(19) United States
(12) Patent Application Publication
(10) Pub. No.: US 2011/0276430 A1
(43) Pub. Date: Nov. 10, 2011

(54) System And Method For Online Obtainment And Publishing Of Information Of Products

(76) Inventors: Mool Raj Vyas, Kanpur (IN); Arun Purohit, Pune (IN)

(21) Appl. No.: 13/101,239

(22) Filed: May 5, 2011

(30) Foreign Application Priority Data
May 5, 2010 (IN) 1425/MUM/2010

(51) Int. Cl. G06Q 30/00

(52) U.S. Cl. 705/26.8; 705/27.1

(57) ABSTRACT

A system and method for online obtainment and publishing of information of products is provided. The system includes a server further including a database to store records containing information of products. A registration means registers third party users and sellers. Input acceptance means accepts inputs containing information of products from third party users and/or sellers and provides the inputs to the database for storage. Index price determining means is used to extract and sort the records stored in the database based on their product prices and determines index prices for the products whose information is stored in the database, based on the sorted records. The records are verified using verification means and further to verification, the records are transmitted to a plurality of nodes where the records are displayed in predefined manner and third party users' feedback are received using input means.

### FIELD OF THE INVENTION

This invention relates to the field of electronic commerce. Particularly, this invention relates to price obtainment using electronic means.

### DEFINITIONS

In this specification, the following terms have the following definitions as given alongside. These are additions to the usual definitions expressed in the art.

Product: Product means yield of any company and includes items, goods, services, and articles.

Transportation cost: Transportation cost is the money required to transport or move a product from one location to another (preferably from a seller location to a buyer location). It includes, but is not limited to cost of maintenance of vehicle, fuel cost and insurance premium cost.

Time cost: Time cost relates to money which is equivalent to the time invested in a particular task. Specifically, this term is useful for professionals. For instance, a professional earning Rs 600,000/annum earns Rs 50,000 in a month; if he/she works 45 hours/week or 180 hours/month, so the hourly cost is Rs 50,000/180 hours or Rs 278 approx. The time cost for this professional for 2.5 hours will be calculated as Rs 278*2.5 which is equal to Rs 695 or 700.

Landing price: Landing price of any product is the sum of selling price, transportation cost, time cost and other/miscellaneous costs like octroi and other local taxes.

Trust score: Trust Score is a measure of trustworthiness of a user. For instance, a user with trust score of 100 out of 100 is trust worthy and always provides correct information.

Truth score: Truth Score is a measure of accuracy/truthfulness of a piece of information. For instance, a piece of information relating to a product price having a truth score of 100 out of 100 indicates that the product price information is accurate and trust worthy.

Active map: Active Map is a digital or electronic map available for use on computers, mobiles, PDA's, tablet PC's and the like devices. Locations can be tagged or marked on the Active maps. Also, prices and price patterns available at a place can be displayed by numbers or geometric curves on the active maps.

User: A user of this system can be a buyer, price information seeker, price information contributor, reporter, seller, price validity contributor and their agents or representatives. Briefly, a user is any individual or organization providing and/or consuming information.

Index Price: Index price relates to a minimum or lowest price/landing price of any product, service, article or good provided by a user. The index price is always lower as compared to the prices provided by other users.

Obtainment: The term obtainment inter alia includes seeking, indexing, finding, knowing and displaying information related to price, products, sellers, purchasers and suppliers.

### BACKGROUND OF THE INVENTION

Today, electronic commerce has become the most accepted form of commercial transaction especially in case of cross border and cross continent trade. Users/buyers find it easy and faster to traverse through wide range of goods, commodities and services (generally referred as products) just at a click of a button.

This has also led to tremendous rise in the competitive nature of trade and business, as buyers today are open to numerous markets and thousands of suppliers (sellers, wholesalers, manufacturers, retailers). Buyer are always looking for the best deal in terms of price, quality, quantity and time of delivery and seller are looking for markets where margin and profits can be maximized.

Many systems for such e-commerce applications have been proposed and implemented before like eBay a portal for buying/selling of products. The eBay portal facilitates trade by letting sellers upload their product details which they wish to sell using eBay and buyers can choose amongst them a seller who is giving the best deal. In such systems one of the basic issues is the price being set by the sellers. The sellers set the price such that it gives them maximum profits, and in doing so sometimes the best price is not available to the buyers. Also, the prices displayed are limited to sellers affiliated to such systems.

Moreover, systems like eBay though meant for everything are mostly used for trade in electronics, jewelry, textiles, and the like modern articles and are less commonly used for services, home amenities, day to day articles and the like.

Also, one has to make purchases online to take advantage of the price provided by the seller and requires buyers to order for a product without actually seeing the product and its features which at times leads to misunderstanding about the product and also leads to erroneous trade.

Other online shopping sites like home shop 18, indiatimes shopping also works on similar lines to eBay and at times leads to erroneous trade, swindling and dissatisfaction regards to shopping. Also, some of these shopping systems and portals do not clearly state the final price on delivery (landing price).

Majority of manufacturers mark a sale price for their product. They give a rebate on this MRP (Maximum Retail Price) to their major distributors. The various players in the selling chain keep exploiting this MRP till it reaches the final retailer who may choose to sell it at its MRP or less than it. Often stores have been found notorious of pasting a bar-coded sticker containing significantly higher price than manufacturer's marked price and offering discount on it. MRP does not mean that the retailer cannot sell cheaper than this. However, in absence of fair amount of information, the trend is to sell everything at ‘Maximum’ retail price or more which is against the interest of end buyer who is interested in and is benefited by ‘Minimum Retail Price’ which currently is not mentioned anywhere.

Some of the shopping systems have tried to facilitate fair pricing, where a buyer can identify vendors and prices for goods/products/services and then take a decision. For instance, www.books.com uses a pricing agent (“Price Compare”) to price items it sells and holds in its inventory. It uses the shopping agent to query several competitors and, if its price for a new book is not less than its competitors' prices, the pricing agent sets the price for its new book at less than the lowest competitor's price for the same new book. However, the seller still controls the price since its price agent determines the fixed number of competitors for obtaining the price and only their prices are used for setting a competitive price while those not having an online presence are excluded. In addition, the seller is required to maintain a substantial inventory of books.

The United States Patent application 2005/0159974 discloses techniques for aggregation and use of local retail information for the purpose of local retail and for aiding the consumers. But, this information is gathered from advertisements of local retailers or sellers. The information of sellers who are not advertising or whose advertisements are inaccessible is not provided. Such sellers in some cases may sell the products at more competitive prices.

Also, the approaches currently present do not show the pricing patterns which can help corporate buyers to take decisions.

Hence, there was felt a need for a system:
which facilitates obtainment of pricing patterns in a subject geography by soliciting prices primarily from buyers/end users/friends network and enables buying/selling of goods at most optimal prices realizable;
which attempts to find and display the Minimum available Price of goods/service;
which attempts to verify the obtained prices;
which helps to find effective landing prices for users; and
which encourages the users to report the price at which they actually bought a product or service after negotiation and haggling.

### OBJECTS OF THE INVENTION

It is an object of the present invention to provide a system for facilitating obtainment of prices and selling of products/goods/services.

It is another object of the present invention to provide a system for obtainment of pricing patterns in subject geography and buying/selling of goods.

It is still another object of the present invention to provide a system for finding the minimum available price of products/goods/services.

It is yet another object of the present invention to provide a system for determining the effective landing prices for users.

Further, another object of the present invention is to encourage the users to report the price at which they actually bought a product or service after negotiation and haggling.

Still further, another object of the present invention is to provide a cost effective and time effective system for obtaining location relevant price and selling information of products/goods/services.

One more object of the system is to provide a graphical iso price line trade optimizing tool, which helps in dynamically finding more efficient trade opportunities across different geographies.

An additional object of the present invention is to verify the prices obtained from user, particularly the reported lowest price using social feedback.

### SUMMARY OF THE INVENTION

The present invention envisages a system for online obtainment and publishing of information of products, the system comprising:
a server comprising:
   a database adapted to store a plurality of records containing information of products selected from the group consisting of product types, brands, product qualities, product prices, seller identification details, terms and conditions of sale, index price of the products, location of availability and tentative date of delivery;
   registration means adapted to register a plurality of third party users and sellers by storing their identity information in a registration database;
   input acceptance means adapted to accept inputs containing information of products from a plurality of third party users and/or sellers and further adapted to provide the inputs to the database for storage;
   index price determining means adapted to extract and sort the records stored in the database based on their product prices and further adapted to determine index prices for the products whose information is stored in the database, based on the sorted records;
   verification means having social feedback means adapted to receive third party users' feedbacks and further adapted to verify the information of products stored in the database based on the third party users' feedbacks;
   transmission means adapted to transmit the records stored in the database along with third party users' feedbacks and the determined index prices;
   processing means adapted amongst other functions to process online obtainment and publishing of information of products and further adapted to control and instruct the server, the registration means, the index price determining means, the verification means and the transmission means; and
a plurality of nodes adapted to receive transmitted information including the records from the database along with the third party users' feedbacks and the determined index prices, each of the plurality of nodes comprising:
   display means adapted to display the received transmitted information in a predetermined manner; and
   input means adapted to accept users inputs related to the feedback on the prices of the products provided by other users and transmit it to the social feedback means.

Typically, the server further comprises computing means adapted to receive the information of products stored in the records from the database and further adapted to add transportation cost, time cost and miscellaneous cost associated, wherein the transportation cost, the time cost and the miscellaneous cost are extracted from a secondary database.

Typically, the server further comprises:
a map repository adapted to store a plurality of co-ordinates and data points in a predetermined geographical region;
geographical mapping means adapted to obtain a map of a predetermined geographical region and further adapted to tag co-ordinates and data points on the map corresponding to locations which show information of the products stored in the records of the database, the records being related to products of interest;
iso price line drawing means adapted to communicate with the geographical mapping means and further adapted to draw distinct lines joining tags on the map to display information on the location of availability of identical products at the price selected from the group consisting of same price and approximately same price, wherein each of the distinct line represents an iso price line; and
a map based interface adapted to enable users to drill down to a particular location on the map to see street level information.

Typically, the server further comprises potential market recommending means adapted to analyze and determine regions in the iso pricelines which display change in prices.

Typically, the server further comprises:
trust score ranking means adapted to assign initial trust score ranking to the third party users capable of providing information of products during registration and further adapted to dynamically modify the trust score rankings of the third party users, based on authentication of the information by the information provided by other third party users or sellers; and
truth score ranking means adapted to assign truth score rankings to the information of the products provided by the third party users and further adapted to dynamically modify the truth score rankings of the information provided by the third party users, based on authentication of the information by other third party users or sellers.

Typically, the server still further comprises:
contest generation means adapted to initiate contest amongst third party users for finding and providing information of the products including competitive prices for the products stored in the database along with location of availability and seller information;
user rewards calculation means adapted to calculate reward points to be given to the registered third party users based on their trust score rankings and the truth score rankings of the information provided by them and value of the information at a pre defined intervals wherein the value of the information is calculated on the basis of rules selected from the group consisting of number of people seeking the information, the difference between current index price, first time reporting of information of a product and first time validation of information of a product; and
storing means adapted to store the reward points each user providing information is entitled to, into the registration database.

Typically, the server additionally comprises
a recurring purchase repository adapted to store recurring purchase lists containing information of products to be purchased and the interval at which users wish to purchase the products;
recurring purchase facilitation means adapted to search and extract the records containing minimum prices of said products in said purchase list within specified regions; and
order placing means adapted to place the orders with the sellers whose information is present in the extracted records.

The present invention also envisages a method for online obtainment and publishing of information of products, the method comprising the following steps:
providing a server maintaining a database to store records containing information of products selected from the group consisting of product types, brands, product qualities, product prices, seller identification details, terms and conditions of sale, index price of the products, location of availability and tentative date of delivery;
storing new records into the database containing the information of the products, wherein the information of the products is submitted by third party users and sellers accessing a plurality of nodes;
sorting various records corresponding to each of the products based on the prices of the products;
determining the index prices for the products from the sorted records;
verifying the prices of the products using social feedback of other third party users;
transmitting the records to a plurality of nodes;
receiving records from the server at the nodes, containing information of the products selected from the group consisting of seller identification details, price, terms and conditions of sale, index price of the products, tentative date of delivery and other relevant information; and
displaying at least some of the records in a pre-defined manner at the nodes, wherein the records are related to at least one product of interest.

Typically, the step of storing new records into the database containing information of the products, wherein the information of the products is submitted by third party users and sellers accessing a plurality of nodes, further includes the following steps:
registering the third party users and the sellers with the system by storing the identity information and other related information corresponding to the third party users and the sellers;
assigning initial trust score rankings to the third party users capable of providing information of products; and
assigning truth score rankings to the information of the products provided by the third party users.

Typically, the step of verifying the information of the products using social feedback of other third party users further includes the steps of:
dynamically modifying the trust score rankings of the third party users based on authentication of the product price information by comparing it with the information provided by other third party users or sellers; and
dynamically modifying the truth score rankings of the information provided by the third party users, based on authentication of the information.

Typically, the method further comprises the steps of receiving records from the database and their index prices and computing final selling price by including landing price.

Typically, the step of storing new records into the database containing the information of the products, wherein the information of the products is submitted by third party users and sellers accessing a plurality of nodes, includes the following steps:
initiating contest amongst third party users for inputting competitive prices and seller information for the products including location of availability of the products at those prices;
calculating the reward points to be given to the registered third party users based on their trust score rankings and the truth score rankings of the information provided by them and value of the information at a pre defined intervals wherein the value of the information is calculated on the basis of rules selected from the group consisting of number of people seeking the information, the difference between current index price, first time reporting of information of a product and first time validation of information of a product;
storing the calculated reward points in a reward repository; and
maintaining records containing information of the registered third party users and the reward points each third party user providing information is entitled to.

Typically, the method further comprises the following steps:
providing a map repository in which a plurality of co-ordinates and data points in predetermined geographical regions are stored;
obtaining a map of a predetermined geographical region at appropriate zoom levels and tagging the obtained map with the co-ordinates and data points corresponding to locations within the map to show at least some of the information of the records of the database, the records being related to the products of interest;
drawing distinct iso-price lines by joining tags on the maps to display information of the locations of availability of the products at the price selected from the group consisting of same price and approximately same price; and
enabling users to drill down to a particular location on the map to see street level information.

Typically, the step of displaying at least some of the records in a pre-defined manner, wherein the records are related to at least one product of interest includes the following steps:
displaying a tagged map showing at least some of the information of the records of the database, the records being related to the product of interest; and
displaying iso-price lines by joining tags on the maps to display information of the locations of availability of the products at the price selected from the group consisting of same price and approximately same price.

The method further comprises the following step:
determining regions where cost of the products offered is different and useful to the concerned third party user or seller, by analyzing the iso-pricelines.

The method further comprises the following steps:
submitting a recurring purchase list containing information of products to be purchased and the interval at which users wish to purchase;
storing the lists of the users in a recurring purchase repository;
searching the database and extracting the records containing minimum prices of the products in the purchase list within specified regions; and
placing the orders with the sellers whose information is present in the extracted records.

### BRIEF DESCRIPTION OF THE ACCOMPANYING DRAWINGS

The invention will now be described with reference to the accompanying drawings, in which:

FIG. 1 illustrates a schematic of the system for online obtainment and publishing of information of products, in accordance with the present invention;

FIG. 2 illustrates a sample iso price line map for call center service, in accordance with one of the exemplary aspects of the invention; and

FIG. 3 illustrates a flowchart showing the steps for online obtainment and publishing of information of products, in accordance with the present invention.

### DETAILED DESCRIPTION OF THE INVENTION

The drawings and the description thereto are merely illustrative of a system for online obtainment and publishing information of products and only exemplifies the invention and in no way limits the scope thereof.

As disclosed in the background there are various drawbacks associated with the prior art systems which are specifically online purchasing systems, such drawbacks include limited price data, erroneous trade, opaque pricing for saleable products and like. In order to overcome the drawbacks of the prior art systems, a system for online obtainment and publishing of information of products is provided. The information of products include amongst other information the price at which the products are sold in the market along with details regarding geographical locations of availability of the products (i.e. the seller's location) at those prices.

More particularly, the system of the present invention facilitates obtainment and publishing of information regarding lowest prices at which the products are available in the market (hereinafter referred to as the index prices) along with details regarding geographical locations of availability of the products at the index prices. The information regarding various products and their prices including the index prices are provided by the third party users (such as net surfers, vendors, other buyers, distributors or any other person/entity having information regarding products) and which is processed to make it available to the potential buyers in a precise and concise way, thereby enabling the potential buyers to make wise purchase decisions while buying the products.

In accordance with a first aspect of the present invention, a system for online obtainment and publishing of information of products (goods/services) is provided, where the information of products includes sellers' identification details, prices of the products, terms and conditions of sale, index prices of the products, and tentative date of delivery for every product and other relevant information. More specifically, the information of products include all the information which may be useful to potential buyers for buying a product at fair price which necessarily includes the known price and the information of where a buyer can approach to get products at the specified price entered by them in a particular country, state, city, area, market, store and the like. The information of products is stored in a database as records and a server facilitates the obtainment and publishing of the information of the products through a web page/portal or a web based, custom made application and the like.

Also, the system facilitates the sellers to float their sale proposals for various products. These sale proposals are reviewed/verified by users and also stored in the database as records.

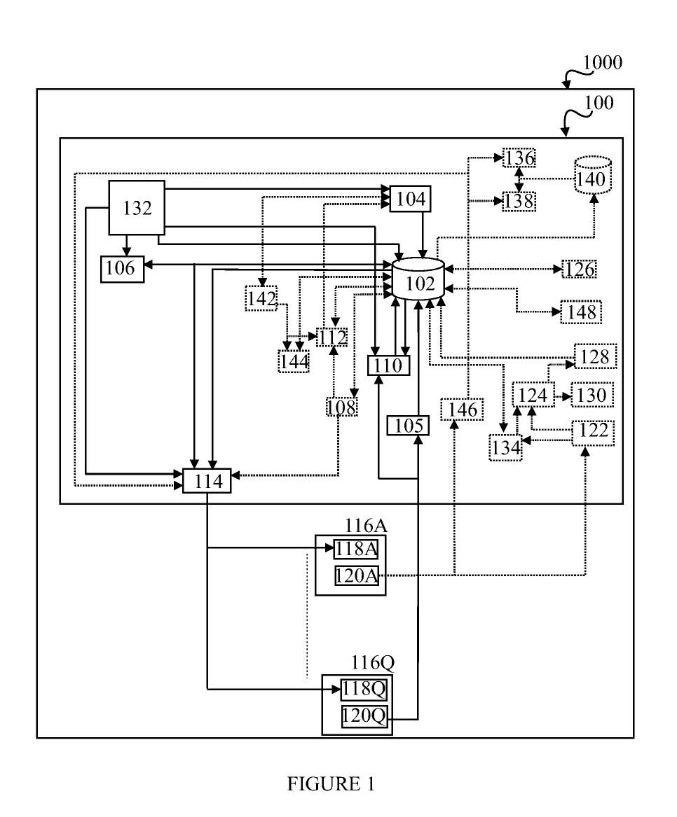

Referring to FIG. 1, there is provided a system 1000 for online obtainment and publishing of information of the products in accordance with an embodiment of the present invention. A server 100 maintains a database 102 for storing information regarding products provided by the third party users and/or the sellers using an input acceptance means 105. The input acceptance means 105 accepts the inputs and provides it to the database 102.

The third party users, sellers, buyers, and potential buyers use nodes 116 (116A-116Q) to view and input the information, these nodes can be computers, laptops, PDAs, IPADs, IPODs, smart phones, mobiles, and the like.

The information provided by the third party users is based on the prices at which they actually bought the products or the prices of the products they are aware of. The information of the products provided by the sellers are basically sale proposals and for such sale proposals the database 102 stores information about the sellers/manufacturers of the products including seller identification details, images and multi-angular views of the products (in case of goods), quantity or number of units of products available with the sellers and the like.

New records containing information about products are provided by third party users or sellers after registration using registration means 104. The registration includes storing the identity information of the third party users and the sellers in a registration database (not shown in the figure).

The information provided by the third party users and sellers is used by the system for determining index prices of the products.

The database 102 also stores index price of every product obtained from index price determining means 106. For every product the index price determining means 106 determines the index price. The prices of the products (or similar products belonging to same type) stored in the database 102 are sorted by the index price determining means 106 and the minimum of these sorted prices is selected for every product, these minimum prices are the index prices.

The information regarding the products as provided by the third party users and the sellers is stored in the database 102 as records. For instance, FIG. 1 shows a node 116Q operated by a third party user, storing or feeding information relating to a product, its price and location of availability of the product at that price, number of units and the like in the database 102. All such information regarding the products is then verified using verification means 110 which verifies the information of products in the records stored in the database 102 to provide a feedback to the system. As shown in FIG. 1, the node 116Q is operated by a third party user who is verifying the information of a product stored in the database 102. The verification means 110 includes a social feedback means (not shown in the figure) which receives other third party users or sellers feedbacks to verify the information of products as provided by other third party users or sellers, manually (i.e. by social feedback) and employs IT enabled infrastructure acting as interface for verification by third party users.

To motivate third party users to provide correct prices, contest generation means 108 conducts a contest between various third party users. The participant third party users are rewarded based on certain parameters including degree of authenticity of the information provided by them, and trustworthiness of the third party user providing it, thereby encouraging the third party users to provide authentic information regarding the products including the price, seller details, location of availability, terms and conditions of sale, quantity and the like of the products (or similar products) stored in the database 102. The rewards can be either in monetary terms or gift hamper/voucher and the like. This contest may be conducted periodically on a monthly/quarterly/weekly/daily or on need basis and can be conducted for separate products or collectively for a group of products or all the products. The information regarding the contest is made available on the nodes 116A . . . 116Q, accessed by third party users.

The server 100 further includes a trust score ranking means 142 which initially assigns trust score rankings to the third party users at the time of registration and dynamically modifies the trust score rankings of the third party users who provide information of products including the prices of the products stored in the database 102 using certain pre-defined parameters. For instance, these parameters can be but not limited to trustable identity information, regular submission of information, financial status, professional status, education status and the like.

These trust score rankings of the registered third party user's are stored in registration database (not shown in figure) maintained by the registration means 104.

According to an exemplary embodiment of the present invention the trust score can be calculated as follows:

Trust Score:
1. Classifying the user types: The classification is done on the basis of history of correct information. For instance, the exemplary system may have:
   Totally trusted user: A totally trusted user is a user having rank in the range of 91-100% and who always gives true information (sans some grammatical error or changes by seller later on);
   Highly trusted user: A highly trusted user is a having a rank in the range of 61-90% and who mostly gives true information;
   Average trustable user: An average trustable user is a user having a rank in the range of 41-60% and who gives true information at times;
   Low trustable user: A low trustable user is a user having a rank in the range of 11-40% and who mostly gives false or misguiding information; and
   Non trustable user: A non trustable user is a user having a rank in the range of 0-10% who always gives false information.
2. Seeding or providing the default value for initial trust score of an individual: During registration with the system user gives some personal information which increases or decreases the trustability. For instance, a user joining anonymously or with fake identity and with fake information (geeklord@fakemail.com) will have low initial trustability or trustworthiness in comparison to a person from a more credible credentials viz. rabc_i@crediblecompany.com.
   Further, there can be more parameters depending on the credentials provided by an individual and weightage assigned to that credential. A person may have a perfect, high low or zero trust score and may be classified in any of the five categories of the truth score. For instance, the parameters which are considered for assigning a trust score include name, contact details, bank details or other identity information, educational details and employment details.
3. Change in Trust score of individuals: As registered individuals with an initial trust score start providing information using the system, depending on the correctness of the information and weightage given to that information, the trust score of the person increases or decreases and has a value which can be between 0 to 100%.
4. The parameters affecting the change in the trust score of individuals are correctness of submitted information, correctness of product details, product price and correctness of seller details.
5. There are other factors influencing the trust score like expertise in the concerned area, related occupation, number of other non related users subscribing to or following his/her contributions and previously earned rewards. However, certain other factors also affect the trust score of individuals, for instance a person who keeps doing different transactions his/her trust score keeps changing. The system gives a good classification of individuals with high trust scores which are across all categories, based on selected product categories and across a selected city or a selected region. Different individuals and businesses can benefit from consulting such high trust and high impact performers on portals to save money on their purchases and also potentially hire them.

The server 100 still further includes truth score ranking means 144 which initially assigns a truth score ranking to the information of the products during submission and dynamically modifies the truth score ranking of the information of the products including the competitive prices of the products using certain predefined parameters. For instance, these parameters can be the information supporting documents by quoting bill of purchase, verification by users with higher trust score, trust score of the submitter and prices submitted by the sellers themselves.

These truth score rankings of the registered third party user's are stored in database 102 along with the information of products.

According to another exemplary embodiment of the present invention the truth score of submitted information can be calculated in the following way

Truth Score of submitted information: Just like Trust score of individuals a unique dynamic value (truth score) is also assigned to the submitted information of products which ranges from 0-100%. For instance, a price information given by a user with Trust score 100 and whose last N (N may be two or more) transactions had a final truth score of 100 may have a truth score of 100. Similarly, the truth score of any price information may start with a seed value, depending on the trust score of submitter and the supporting verifiable supporting arguments. The truth score may decrease when a person of much higher trust score validates pricing information submitted by other user and reports adversely on its veracity. Dynamically, the price can increase and/or decrease and on its discretion and subject to larger interest of community the system may initiate independent verification and show the trusted score/verified sign with 100% truth score. The factors which may contribute to increase in Truth score are trust score of submitter, purchasing user submitting the information, documents supporting information, direct URL link for ease of confirmation.

The rewards to be given to the third party users are calculated using reward calculation means 112 which calculates the reward points to be given to the registered third party users based on the value to information relating to different products, volume of contribution, trust score rankings of the third party users and the truth score rankings of the information provided by them at the pre defined intervals. The value of information is calculated using rules which are selected from number of people seeking the information, the difference between current index prices, first time reporting of information of a product and first time validation of information of a product. These reward point values are stored in registration database (not shown in figure) maintained by the registration means 104 using a storing means (not shown in figure).

In accordance with yet another exemplary embodiment of the present invention the reward mechanism on price reporting is explained hereinafter.

The system 1000 classifies all users and the activities performed by the users as desirable or undesirable actions. Each desirable action entitles users to avail reward points. The users keep accumulating reward points for all desirable actions and lose points for undesirable actions. A static counter (not shown in the figures) communicably coupled to the system 1000 maintains the sum total of all points for a given duration represented by system total points, for instance (User 1. points+ . . . +User N. points). The System 1000 initially sets aside money as rewards and subsequently adds a fraction of its revenue (say up to 25%) to rewards say rewards amount weekly. For instance, the system index for the week is calculated as: weekly index=rewards amount weekly/system total points. Consequently, the money won by each individual user ‘M’ is equal to (points of user ‘M’)*(Weekly Index). Essentially, higher the desirable actions higher are the point credits. And higher the quality of action, greater are the points credited and hence, greater earning by individuals. For instance, the desirable actions can be:
i. reporting cheaper prices for products which maximum number of people are seeking;
ii. reporting newer sellers and locating them on a map and giving traders' contact pointers;
iii. inviting more users to contend on the portal;
iv. validating and completing the price information submitted by other users;
v. providing more authentic supporting information on the portal, for example proof of purchase; and
vi. volunteering and correctly verifying the prices in an area of reach.

Also, to aid in marketing of certain product the reward money can be given in the form of gift hamper or gift voucher.

The third party users may be blacklisted from the system 1000 in case of adopting fraudulent practices during information submittal and verification. More specifically, if a third party user is not found authentic i.e. the product details provided by the third party is not in-line with the actual facts (for e.g. price provided by a third party user and the actual price at which product is being sold), then the system blacklists the third party user or downgrades his/her trust score ranking and the truth score ranking of the information submitted by him/her.

In accordance with still another exemplary embodiment of the invention to avoid fraudulent information submission, the system employs the concept of degree of separation.

Degree of Separation: The system may attract fraudulent information providers to connive and generate demand for information, enter information and get it validated by other known users. In order to eliminate the exploitation of the system by users forming groups where first group requests price information, second group submits information and third group validates it; the system utilizes a degree of separation technique. The degree of separation verifies the relationship between requester, submitter and person validating the product prices. As per established fact, the largest degree of separation between any two individuals on earth is six. Between two regularly interacting persons is considered one. The parameters to be considered to ascertain degree of separation are blood relation, social connection, professional connection, proximity of the IP addresses and the like. These parameters described above in combination give a fair enough chance for an open collaborative system to get a very high probability of trustable information.

Further, the records in the database 102 are sent to nodes 116 (116A-116Q) using a transmission means 114. The nodes 116 (116A-116Q) are connected to the server 100 by connections including Internet, 4G, 3G, GPRS, WiMax, EDGE and the like. All the connected nodes represented by 116 display the database records including seller information, product information, index price, location of availability of the product priced at third party users provided prices, index prices along with location of availability of the products at the index prices, terms and condition of sale, quantity of products and the like using display means 118 (for instance the display means 118 can be monitors of computers/laptops, mobile screens, LCD screens, LED screens and the like).

The display means 118 also displays maps showing the locations of availability of products (products of interest). A map repository 140 stores a plurality of co-ordinates and data points in predetermined geographical regions.

Further, a geographical mapping means 136 obtains a map of a predetermined geographical region and tags the obtained map with the co-ordinates and data points corresponding to the locations within the map to show at least some of the information of the records of the database, the records are related to the products of interest. The geographical mapping means 136 obtains these maps from some third party online web portals, web applications or the like.

An iso price line drawing means 138 is also provided with the server 100 which communicates with geographical mapping means 136 to draw distinct lines joining tags on the maps which display information of the locations of availability of the products at the price selected from the group consisting of same price and approximately same price. These distinct lines are known as iso pricelines. These iso price lines can be seen as a map for a particular commodity or service in a particular geographical area. These iso price lines distinctly join the location of availability of similar products at equivalent or near equivalent prices within a specified region.

A map based interface 146 communicating with the geographical mapping means 136 and iso price line drawing means 138 enables users to drill down to a particular location on the map to see street level information using their nodes 116. For instance, FIG. 1 shows the buyer using node 116A, using the map based interface to drill down a map to see street level information of the seller who is selling the product at a particular price.

The server 100 also includes potential market recommending means 126 which co-operates with iso priceline drawing means 138 to determine regions where cost of the products offered is different and useful to the concerned seller and may increase his gains. Typically, the potential market recommending means 126 recommends to the sellers whose sale proposals are stored in the database 102 the markets/locations where the index price or generally prevailing prices are higher than their current selling price, thus letting the sellers avail higher profits. Also, the potential market recommending means 126 helps buyers find out places where the products are available at index or near index price.

In accordance with still another exemplary embodiment of the present invention the iso price line maps for call center service are generated in the following way. Global view of iso price lines for call center services is shown. Cost of the call center service is directly dependent on wages of people capable of performing this service. This in turn is dependent on cost of living in a given city and also the availability of such professionals in the city. This will help people find new outsourcing or trade opportunities.

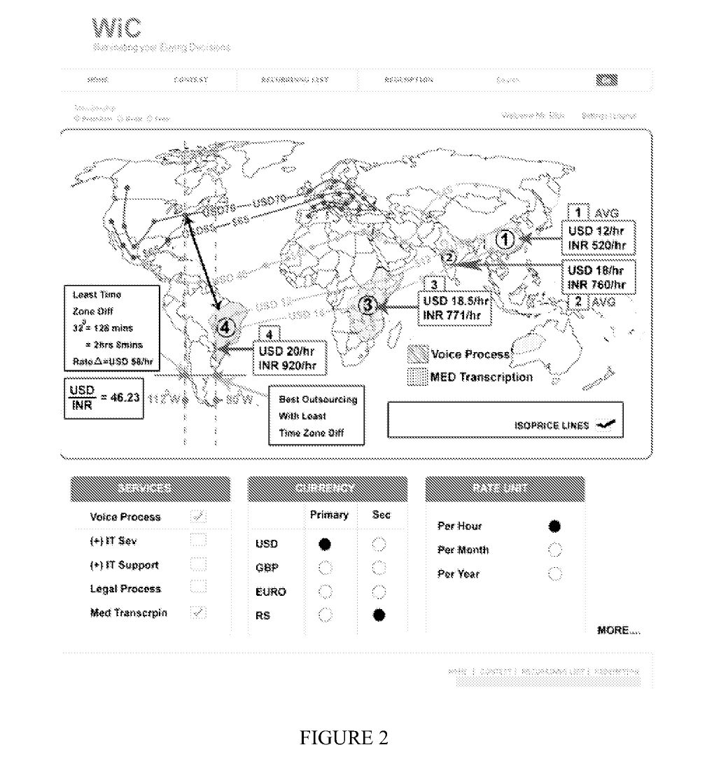

FIG. 2 shows the best outsourcing destinations for Voice Processes. The map depicts that cost of living is high in the Canadian cities, densely populated US cities and the prosperous cites of Western Europe like London, Stockholm and Paris. However, cities of Mexico and some cities of southern Europe like Lisbon and Uruguay offer lower cost of living.

Similarly, the cheapest cities may be some towns of Argentina, East Africa, portions of India and then South East China, and Philippines and the like.

As a result highest iso price lines passes through most expensive cities, and lowest iso price lines passes through some of the cheapest cities. As per economic analysis, the highest iso pricelines may also be because of large gap in supply of this service and also cheapest price may be because of over supply.

Now businesses in highest price zones will benefit by finding lowest priced zones shown by reference numeral 1, 2, 3, 4 on the map. Also, the buyer in highest priced zone will be interested to know, which region on the lowest price zone gives him/her, the least time zone difference (As good as having the person work in same area at ⅕th of the current cost).

Similarly, the producers in western part of India may find that it is productive to sell services at maximum margin to East Europe than to the US. This has a time zone difference of only 4 four hours and hence convenient to employees.

Also, backed by IT infrastructure, the maps can change fast and provide sellers opportunity to sell even at higher rate during peak periods. This ready information on the map is easy to understand and can help people to quickly spot opportunities thus aid trade in a big way.

Further, the areas which currently do not have iso price lines and see a huge gap in supply can plan to build competency and gain businesses.

The invention primarily proposes display of location of sellers selling similar products at equivalent prices within a specified region using iso price line, however, it is within the scope of the invention to display the information in the form of reports, articles or images which may either be digital or physical.

A processing means 132 is provided to process online obtainment and publishing of information regarding products including index prices of specified products and further adapted to control and instruct the server 100, the registration means 104, index price determining means 106, verification means 110 and the transmission means 114 as per pre defined rules.

If a potential buyer connected to a node 116A wants to purchase a particular product, he/she can select the product displayed on the node using display means 118A using input means 120A which includes order facilitation means (not shown in the figure). The information of selection of product is then sent to the server 100 where it is received by receiving means 122 which initiates sale transaction by letting the buyer to connect to the billing means 124 to pay for the selected product using a payment gateway. The price of the product is determined by the computing means 134 which adds to the seller price, the transportation cost and miscellaneous cost, these costs are extracted from a secondary database (not shown in figures). Once the payment is made, the server is notified using notification means 128 by making an entry in the database 102. The finalizing means 130 then processes the sale and initiates the process of physical delivery at the seller's end.

The landing price is computed by the computing means 134 using the data stored in the secondary database is also stored in the database 102 with records. The secondary database is populated by a provisioning means (not shown in figure) which is adapted to accept the information relating to landing cost, transport cost and the miscellaneous cost. More specifically, separate web services are employed by the provisioning means to calculate to-fro distances between user's current location and points of sale. Also, the time cost of procuring the product is determined by the provisioning means by considering the hourly earning rate of individuals. Alternatively, discreet automated systems are employed to populate the database.

In accordance with one more exemplary embodiment of the present invention the transport costs adjustments are a function of to and fro distance. The user interacts with the system through a networked computer or a hand held device. These devices have an IP address (Internet Protocol) and also GPS system for some handheld ones which helps in identifying the user with CEP (Supported Circular Error of Probability). Thus, it is possible to predict the current position of a user with a fair degree of accuracy. Alternately, when current position of user is not displayed correctly s/he can correct it by dragging it to correct location or specifying the location. The map, then displays the current position of the user and the best N (Integer ten or an integer as preferred by user) sellers (Points of sale or PoS) are shown on the map and the one way or two way distances of all the PoS from the user's current location can be calculated.

The transport cost normally includes the acquisition cost, fuel and wear or maintenance cost/km.

The cost of acquisition of the vehicle is the money paid either upfront or paid through EMI over its life by the owner. Interest cost is also added to consider the cost of acquisition. For instance, on a vehicle costing Rs 300,000, if a person has taken 80% loan i.e Rs 240,000, the EMI for 5 yr loan period at 10% will be approx Rs 6000. The total cost including interest cost becomes (60*6000)+60000=Rs 4, 20,000. Considering the life of a car to be 100,000 km and salvage value at end as Rs 20,000. The average cost of acquisition Rs/km of usage is (Rs 4, 20,000-20,000)/100000. That is Rs 4/km. Thus, average cost of acquisition of a car costing Rs. 300,000 is say Rs 4/km.

The fuel cost of running it is the average cost of fuel and the mileage offered by vehicle. For instance, if the fuel cost is Rs 60/litre and the vehicle's mileage is 15 km/litre then the fuel cost/km is Rs 4.0. When the best stores in town are shown on a map distance one has to travel can be conveniently calculated using the mapping services commercially available. The simplest way is to multiply the two way distance by cost/km for the selected vehicle. On an average this works out to be Rs 4/km

The maintenance cost includes two major cost components: routine servicing of vehicle and the insurance premium cost.

For instance, routine servicing of vehicle involves replacing fluids (Engine oils, brake fluids, gear oil etc), doing adjustments (Clutch, brakes, transmissions, etc) and is on average Rs 3000 to 12000 (considering average to be 6000) per year depending on the vehicle for an average running of 6000 km/yr. For an average vehicle this comes out to be Rs 1/km.

For instance, insurance cost for a standard vehicle clocking 6000 km/yr comes out to be varies from Rs 6000/yr to Rs 18000/yr depending on the current depreciated value of the vehicle, on an average this comes out be at least Rs 1/km.

Thus, the maintenance cost on an average can be the sum of routine servicing of vehicle and the insurance premium cost at least Rs 2/km.

Further, the human time cost includes time to reach a store, pick an article, get the billing done, load the article in vehicle, driving back, and unloading. For instance, vehicle start up time: three minutes; driving time: thirty minutes; time taken in parking and locating the store: ten minutes; finding the product: ten minutes; getting the bill done: ten minutes; driving back home: thirty minutes; parking and unloading: seven minutes totals up to hundred minutes or 1.6 hrs. Considering a professional earning Rs 600,000/annum, his monthly earning is Rs 50,000; considering 45 hours of work/week or 180 hours/month, so the hourly cost is Rs 50,000/180 hours or Rs 278 approx. The time cost for this professional for 1.6 hours is: Rs 278*1.6 Rs 445 or say Rs 450. Thus, it is apparent that for a professional to drive a car to a store twenty Km away (forty km for two way) is the transport cost and time cost combined for a picking up a product from the store: Rs [40*(4+4+2)+450]=Rs 950. The miscellaneous costs can be, for example any toll tax paid during the trip and the like.

Often people are lured by deals shown in TV, Newspaper and SMS and impulsively drive down to pick up the product or products without determining the latent cost. Effectively, a next door store charging Rs 950 to the person works out to the same cost. This also builds a business case of win-win where the product can be purchased from the store nearby which saves time and efforts of the buyer. Also, the store can deliver the product to the person at home for cheaper store price+Delivery charges (For example Rs 300 or more).

These costs are added to the price of the product and landing price is calculated.

The system also facilitates recurring purchase; the users can submit the recurring purchase list containing information of products to be purchased and the interval at which users wish to purchase, this list is stored in a recurring purchase repository (not shown in figure). A recurring purchase facilitation means 148 is provided which at the specified intervals searches the database 102 for the records containing minimum prices of all the requisite products in the specified region. Further, a order placing means (not shown in the figure) finalizes the purchase by placing the orders with the sellers whose information is present in the extracted records.

In accordance with an additional exemplary embodiment of the present invention the system facilitates recurring purchase of grocery as follows: Grocery which is bought on a monthly basis usually has ¾th of the grocery items belonging to the same brand and bought of same denomination every month. In order to prevent time, money and endeavors involved in going to the store, picking them up, putting them it in a cart, dragging it to the counter, and getting the billing done manually, the invention proposes an elegant solution. Using the system the users or consumers can select each item of grocery by manufacturer, brand, and quantity. The existing brands appear in the drop down list and if not available, user can suggest a new item. Further, the system fetched details for all these items including their MRP. The system then multiplies the price with quantity selected to find cost of each item. The system then searches the database (populated by the users) for the cheapest seller for each item in the city.

Further when sufficiently large numbers of people configure these lists online before a set date say 24^{th} of a month, the system then aggregates the requirements and procures the items from the cheapest sellers and packages them customer wise. On the agreed date, say 1st day of every month payment is made from customer's account and confirmation is sent to the customer. Thus, the customer is benefited by lower cost (product is sourced from cheapest sellers), lesser time is involved (customer is saved pain of picking the non discretionary items over and over every month), better method (customer gets to order online and fix the number of recurrences, date of pick up/delivery and modes of payment). Thus the system provides a faster, cheaper and better alternative for recurring purchases.

Also, to facilitate buyers to buy any product by physically visiting a store the cheapest possible price amongst all the prices provided by third party users of the products and the location where the products are available at that price is sent to the nodes 116 and displayed using display means 118. This enables the buyers to decide by making trade off between a feasible location and price.

The system also includes advertising means (not shown in figures) to advertise about products in order to generate revenues for the system operators.

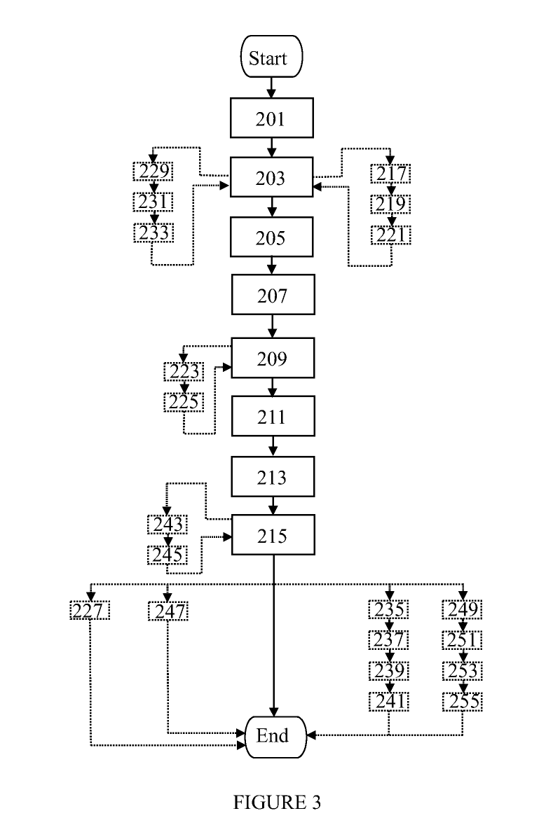

Referring to FIG. 3, there is provided a method for online obtainment and publishing information of products in accordance with the present invention, the method comprising:
providing a server maintaining a database adapted to store records containing information of products selected from the group consisting of seller identification details, prices, terms and conditions of sale, index prices, and tentative date of delivery and other relevant information, 201;
storing new records into the database containing the information of the products, wherein the information of the products is submitted by third party users and sellers accessing a plurality of nodes, 203;
sorting various records corresponding to each of the products based on the prices of the products, 205;
determining the index prices of the products from the sorted records, 207;
verifying the prices of the products using social feedback of other third party users, 209;
transmitting the records to a plurality of nodes, 211;
receiving records from the server containing information of the products selected from the group consisting of seller identification details, price, terms and conditions of sale, index price of the products, tentative date of delivery and other relevant information, 213; and
displaying at least some of the records in a pre-defined manner, wherein the records are related to at least one product of interest, 215.

The step of storing new records into the database containing information of the products, wherein the information of the products is submitted by third party users and sellers accessing a plurality of nodes, further includes the steps of:
registering the third party users and the sellers with the system by storing the identity information and other related information corresponding the third party users and the sellers, 217;
assigning initial trust score rankings to the third party users capable of providing information of products, 219; and
assigning truth score rankings to the information of the products provided by the third party users, 221.

The step of verifying the information of the products using social feedback of other third party users further includes the following steps:
dynamically modifying the trust score rankings of the third party users, based on authentication of the information by the information provided by other third party users or sellers, 223; and
dynamically modifying the truth score rankings of the information provided by the third party users, based on authentication of the information by other third party users or sellers, 225.

The method further comprises the step of receiving records from the database and their index prices and computing final selling price by including landing price, 227.

The step of storing new records into the database containing the information of the products, wherein the information of the products is submitted by third party users and sellers accessing a plurality of nodes, includes the following steps:
initiating contest amongst third party users for inputting competitive prices and seller information for the products including location of availability of the products at those prices, 229;
calculating the reward points to be given to the registered third party users based on their trust score rankings and the truth score rankings of the information provided by them and value of the information at a pre defined intervals, wherein the value of the information is calculated on the basis of rules selected from the group consisting of number of people seeking the information, the difference between current index price, first time reporting of information of a product and first time validation of information of a product, 231; and
storing the calculated reward points in a reward repository maintaining records containing information of the registered third party users and the reward points each third party user, providing information, is entitled to, 233.

The method further comprises the following steps:
providing a map repository in which a plurality of co-ordinates and data points in predetermined geographical regions are stored, 235;
obtaining a map of a predetermined geographical region at appropriate zoom levels and tagging the obtained map with the co-ordinates and data points corresponding to locations within the map to show at least some of the information of the records of the database, the records being related to the products of interest, 237;
drawing distinct iso-price lines by joining tags on the maps to display information of the locations of availability of the products at the price selected from the group consisting of same price and approximately same price, 239; and
enabling users to drill down to a particular location on the map to see street level information, 241.

The step of displaying at least some of the records in a pre-defined manner, wherein the records are related to at least one product of interest includes the following steps:
displaying a tagged map showing at least some of the information of the records of the database, the records being related to the product of interest, 243; and
displaying iso-price lines by joining tags on the maps to display information of the locations of availability of the products at the price selected from the group consisting of same price and approximately same price, 245.

The method further comprises the following step:
determining regions where cost of the products offered is different and useful to the concerned third party user or seller, by analyzing the iso-pricelines, 247.

The method further comprises the following steps
submitting a recurring purchase list containing information of products to be purchased and the interval at which users wish to purchase, 249;
storing the lists of the users in a recurring purchase repository, 251;
searching the database and extracting the records containing minimum prices of the products in said purchase list within specified regions, 253; and
placing the orders with the sellers whose information is present in the extracted records, 255.

### TECHNICAL ADVANTAGES

The technical advantages of the present invention include in providing
a system for facilitating obtainment of prices and selling of products/goods/services;
a system for obtainment of pricing patterns in subject geography and buying/selling of goods;
a system for finding the minimum available price of products/goods/services;
a system for determining the effective landing prices for users;
encouraging the users to report the price at which they actually bought a product or service after negotiation and haggling;
a cost effective and time effective system for obtaining location relevant price and selling information of products/goods/services;
a graphical iso price line trade optimizing tool, which helps in dynamically finding more efficient trade opportunities across different geographies; and
verifying the prices obtained from user, particularly the reported lowest price using social feedback.

While considerable emphasis has been placed herein on the components and component parts of the preferred embodiments, it will be appreciated that many embodiments can be made and that many changes can be made in the preferred embodiments without departing from the principles of the invention. These and other changes in the preferred embodiment as well as other embodiments of the invention will be apparent to those skilled in the art from the disclosure herein, whereby it is to be distinctly understood that the foregoing descriptive matter is to be interpreted merely as illustrative of the invention and not as a limitation.

1. A system for online obtainment and publishing of information of products, said system comprising:
a server comprising:
a database adapted to store a plurality of records containing information of products selected from the group consisting of product types, brands, product qualities, product prices, seller identification details, terms and conditions of sale, index price of the products, location of availability and tentative date of delivery;
registration means adapted to register a plurality of third party users and sellers by storing their identity information in a registration database;
input acceptance means adapted to accept inputs containing information of products from a plurality of third party users and/or sellers and further adapted to provide said inputs to said database for storage;
index price determining means adapted to extract and sort the records stored in said database based on their product prices and further adapted to determine index prices for the products whose information is stored in said database, based on the sorted records;
verification means having social feedback means adapted to receive third party users' feedbacks and further adapted to verify the information of products stored in said database based on said third party users' feedbacks;
transmission means adapted to transmit the records stored in said database along with third party users' feedbacks and the determined index prices;
processing means adapted amongst other functions to process online obtainment and publishing of information of products and further adapted to control and instruct said server, said registration means, said index price determining means, said verification means and said transmission means; and
a plurality of nodes adapted to receive transmitted information including the records from said database along with said third party users' feedbacks and said determined index prices, each of said plurality of nodes comprising:
display means adapted to display said received transmitted information in a predetermined manner; and
input means adapted to accept users inputs related to the feedback on the prices of the products provided by other users and transmit it to said social feedback means.

2. The system as claimed in claim 1, wherein said server further comprises computing means adapted to receive said information of products stored in the records from said database and further adapted to add transportation cost, time cost and miscellaneous cost associated, wherein the transportation cost, the time cost and the miscellaneous cost are extracted from a secondary database.

3. The system as claimed in claim 1, wherein said server further comprises:
a map repository adapted to store a plurality of co-ordinates and data points in a predetermined geographical region;
geographical mapping means adapted to obtain a map of a predetermined geographical region and further adapted to tag co-ordinates and data points on said map corresponding to locations which show information of the products stored in the records of said database, said records being related to products of interest;
iso price line drawing means adapted to communicate with said geographical mapping means and further adapted to draw distinct lines joining tags on said map to display information on the location of availability of identical products at the price selected from a group consisting of same price and approximately same price, wherein each of said distinct line represents an iso price line; and
a map based interface adapted to enable users to drill down to a particular location on the map to see street level information.

4. The system as claimed in claim 1, wherein said server further comprises potential market recommending means adapted to analyze and determine regions in said iso pricelines which display change in prices.

5. The system as claimed in claim 1, wherein said server further comprises:
trust score ranking means adapted to assign initial trust score ranking to the third party users capable of providing information of products during registration and further adapted to dynamically modify the trust score rankings of the third party users, based on authentication of the information by the information provided by other third party users or sellers; and
truth score ranking means adapted to assign truth score rankings to the information of the products provided by the third party users and further adapted to dynamically modify the truth score rankings of the information provided by the third party users, based on authentication of the information by other third party users or sellers.

6. The system as claimed in claim 1, wherein said server further comprises:
contest generation means adapted to initiate contest amongst third party users for finding and providing information of the products including competitive prices for the products stored in the database along with location of availability and seller information;
user rewards calculation means adapted to calculate reward points to be given to the registered third party users based on their trust score rankings and the truth score rankings of the information provided by them and value of the information at a pre defined intervals wherein said value of the information is calculated on the basis of rules selected from the group consisting of number of people seeking the information, the difference between current index price, first time reporting of information of a product and first time validation of information of a product; and
storing means adapted to store the reward points each user providing information is entitled to, into the registration database.

7. The system as claimed in claim 1, wherein said server further comprises
a recurring purchase repository adapted to store recurring purchase lists containing information of products to be purchased and the interval at which users wish to purchase the products;
recurring purchase facilitation means adapted to search and extract the records containing minimum prices of said products in said purchase list within specified regions; and
order placing means adapted to place the orders with the sellers whose information is present in the extracted records.

8. A method for online obtainment and publishing of information of products, said method comprising the following steps:
providing a server maintaining a database to store records containing information of products selected from the group consisting of product types, brands, product qualities, product prices, seller identification details, terms and conditions of sale, index price of the products, location of availability and tentative date of delivery;
storing new records into the database containing the information of the products, wherein the information of the products is submitted by third party users and sellers accessing a plurality of nodes;
sorting various records corresponding to each of the products based on the prices of the products;
determining the index prices for the products from the sorted records;
verifying the prices of the products using social feedback of other third party users;
transmitting the records to a plurality of nodes;
receiving records from the server at the nodes, containing information of the products selected from the group consisting of seller identification details, price, terms and conditions of sale, index price of the products, tentative date of delivery and other relevant information; and
displaying at least some of the records in a pre-defined manner at the nodes, wherein the records are related to at least one product of interest.

9. The method as claimed in claim 8, wherein the step of storing new records into the database containing information of the products, wherein the information of the products is submitted by third party users and sellers accessing a plurality of nodes, further includes the following steps:
registering the third party users and the sellers with the system by storing the identity information and other related information corresponding to the third party users and the sellers;
assigning initial trust score rankings to the third party users capable of providing information of products; and
assigning truth score rankings to the information of the products provided by the third party users.

10. The method as claimed in claim 8, wherein the step of verifying the information of the products using social feedback of other third party users further includes the steps of:
dynamically modifying the trust score rankings of the third party users based on authentication of the product price information by comparing it with the information provided by other third party users or sellers; and
dynamically modifying the truth score rankings of the information provided by the third party users, based on authentication of the information.

11. The method as claimed in claim 8, wherein the method further comprises the steps of receiving records from the database and their index prices and computing final selling price by including landing price.

12. The method as claimed in claim 8, wherein the step of storing new records into the database containing the information of the products, wherein the information of the products is submitted by third party users and sellers accessing a plurality of nodes, includes the following steps:
initiating contest amongst third party users for inputting competitive prices and seller information for the products including location of availability of the products at those prices;
calculating the reward points to be given to the registered third party users based on their trust score rankings and the truth score rankings of the information provided by them and value of the information at a pre defined intervals wherein said value of the information is calculated on the basis of rules selected from the group consisting of number of people seeking the information, the difference between current index price, first time reporting of information of a product and first time validation of information of a product;
storing the calculated reward points in a reward repository; and
maintaining records containing information of the registered third party users and the reward points each third party user providing information is entitled to.

13. The method as claimed in claim 8, wherein the method further comprises the following steps:
providing a map repository in which a plurality of co-ordinates and data points in predetermined geographical regions are stored;
obtaining a map of a predetermined geographical region at appropriate zoom levels and tagging the obtained map with the co-ordinates and data points corresponding to locations within said map to show at least some of the information of the records of the database, the records being related to the products of interest;
drawing distinct iso-price lines by joining tags on the maps to display information of the locations of availability of the products at the price selected from a group consisting of same price and approximately same price; and
enabling users to drill down to a particular location on the map to see street level information.

14. The method as claimed in claim 8, wherein the step of displaying at least some of the records in a pre-defined manner, wherein the records are related to at least one product of interest includes the following steps:
displaying a tagged map showing at least some of the information of the records of the database, the records being related to the product of interest; and
displaying iso-price lines by joining tags on the maps to display information of the locations of availability of the products at the price selected from a group consisting of same price and approximately same price.

15. The method as claimed in claim 8, wherein said method further comprises the following step:
determining regions where cost of the products offered is different and useful to the concerned third party user or seller, by analyzing the iso-pricelines.

16. The method as claimed in claim 8, wherein said method further comprises the following steps
submitting a recurring purchase list containing information of products to be purchased and the interval at which users wish to purchase;
storing the lists of the users in a recurring purchase repository;
searching the database and extracting the records containing minimum prices of the products in said purchase list within specified regions; and
placing the orders with the sellers whose information is present in the extracted records.
